(19) United States
(12) Patent Application Publication
(10) Pub. No.: US 2023/0229560 A1
(43) Pub. Date: Jul. 20, 2023

(54) METHOD AND SYSTEM FOR OFF-LINE REPAIRING AND SUBSEQUENT REINTEGRATION IN A SYSTEM

(71) Applicant: Micron Technology, Inc., Boise, ID (US)

(72) Inventors: Marco Sforzin, Boise, ID (US); Angelo Visconti, Boise, ID (US); Giorgio Servalli, Boise, ID (US); Danilo Caraccio, Boise, ID (US); Emanuele Confalonieri, Boise, ID (US)

(73) Assignee: Micron Technology, Inc., Boise, ID (US)

(21) Appl. No.: 17/897,037

(22) Filed: Aug. 26, 2022

Related U.S. Application Data
(60) Provisional application No. 63/301,027, filed on Jan. 19, 2022.

(51) Int. Cl. G06F 11/14; G06F 12/06; G06F 11/10

(52) U.S. Cl. CPC G06F 11/1435; G06F 12/0646; G06F 11/1044; G06F 2212/1032; G06F 2201/805

(57) ABSTRACT

There are provided methods and systems for correcting an error from a memory. For example, there is provided a system for mitigating an error in a memory. The system can include a memory controller communicatively coupled to a host. The memory controller may be configured to receive information associated with a memory location. The information can indicate the error at the memory location. The controller may be configured to perform, upon receiving the information, certain operations. The operations can include copying data around the memory location, placing the copied data in a reserved area. And the operations can further include outputting, to a central controller, a set of physical addresses associated with the reserved area, wherein the central controller is configured to modify the set of physical address to conduct a data recovery off-line.

### CROSS-REFERENCE TO RELATED APPLICATION

This application claims priority to U.S. Provisional Application No. 63/301,027 filed on Jan. 19, 2022, titled “Off-line repairing and subsequent reintegration in the system,” which is hereby expressly incorporated herein by reference in its entirety.

### FIELD OF TECHNOLOGY

This disclosure relates generally to one or more systems and methods for memory, particularly to improved reliability, accessibility, and serviceability (RAS) in a memory device.

### BACKGROUND

Memory integrity is a hallmark of modern computing. Memory systems are often equipped with hardware and/or software/firmware protocols that are configured to check the integrity of one or more memory sections and determine whether the data located therein is either accessible to higher level subsystems or whether the data is error-free. These methods fall under the RAS features of the memory, and they are essential for maintaining data persistence in the memory as well as data integrity.

The typical RAS infrastructure of a memory system may be configured to detect and fix errors in the system. For example, RAS features may include protocols for error-correcting codes. Such protocols are hardware features that can automatically correct memory errors once they are flagged by the RAS infrastructure. These errors may be due to noise, cosmic rays, hardware transients that are due to sudden changes in power supply lines, physical errors in the medium in which the data are stored.

One long-standing RAS feature that is used in volatile memories such as random access memories (RAMs), is called patrol scrubbing. This protocol is achieved using a hardware engine that may be co-located with the memory system either as an adjacent module or within the memory itself. During run time, patrol scrubbing accesses memory addresses with a predetermined frequency, and it generate requests that do not interfere with the memory's actual functions and quality of service. Such requests are read requests to the memory addresses that are accessed, and they give the hardware the opportunity to read the data from the memory addresses and run an error-correcting code on the data. If the data is not correctible, the scrubber may report the memory location to the software to indicate that the data at that location is not correctible. The scrubber may be configured to work on single memory addresses, or it may work on pre-determined address ranges. Furthermore, given enough time, the scrubber may access every memory location in the memory.

Compute Express Link™ (CXL™) is a new technology that maintains memory coherence between CPU memory space and the memory of peripheral devices to allow resource sharing and reduced software stack complexity, which improves device speed and reduces overall system cost. In CXL™-mediated devices, a failure (e.g., corrupted data at memory location) is intercepted by the patrol scrubber and the system must immediately react to this failure to ensure high level RAS features are maintained. This may slow down the device and compromise CXL™ speed. As such, there is a need for new approaches to identifying and fixing errors in emerging architectures like CXL.

### SUMMARY

The embodiments featured herein help solve or mitigate the above noted issues as well as other issues known in the art. Specifically, there is provided a system and a method for managing a failure off-line once it is identified by the patrol scrubber of a memory system. The embodiments may manage this failure off-line in either one of two novel ways. The first method includes provisioning a “jolly,” which is a spare component or a spare part of a component (e.g., a bank, a section, or a row) in the memory system. The jolly can be used to temporary replace the failed area in a manner that is impervious to the memory system in general. In this embodiment, valid data may be copied into the jolly area.

After the valid area is safe, memory addressing that is associated to the failed area is redirected to the jolly area. When the failure is no longer visible to higher level system, e.g., it has been fixed by typical fast cycling to promote retention and data integrity at the failed memory location, then a recovery procedure may be undertaken. The recovery procedure may include re-mapping the content of the jolly to the failed area. In this exemplary scenario, areas around the failed area that are valid may also be copied to the jolly area in order to maintain normal system operation.

In another embodiment, the failure may be mitigated without a jolly. In this approach, the controller implementing the failure mitigation may impose that the host retire the failure area. This may be done by removing the addresses of the failed areas from the pool of valid addresses until the failure area has been sanitized. This is achieved with a custom protocol that notifies the host of the status of the retired area.

Further, in one other example embodiment, there is provided a system for mitigating an error in a memory. The system can include a memory controller communicatively coupled to a host. The memory controller may be configured to receive information associated with a memory location. The information can indicate the error at the memory location. The controller may be configured to perform, upon receiving the information, certain operations. The operations can include copying data around the memory location, placing the copied data in a reserved area. And the operations can further include outputting, to a central controller, a set of physical addresses associated with the reserved area, wherein the central controller is configured to modify the set of physical address to perform a recovery off-line.

In another example embodiment, there is provided a method for mitigating an error in a memory. The method can include receiving, by a memory controller communicatively coupled to a host, information associated with a memory location, the information indicating the error at the memory location. The method can further include copying data around the memory location and placing the copied data in a reserved area. The method can further include outputting, to a central controller, a set of physical addresses associated with the reserved area and modifying the set of physical address to conduct a data recovery off-line.

there is provided a method for mitigating an error in a memory. The method may include receiving, by a controller communicatively coupled to the memory, information associated with a memory location. The information may indicate an error at the memory location. The method may include copying, by the controller, data around the memory location, and placing, by the controller, and the copied data in a reserved area. The method may further include returning, by the controller, a set of addresses to a host controller of the memory. The set of addresses may be associated with the reserved area, and the set of addresses may replace a corresponding set of addresses of the memory location that was flagged as having an error.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A illustrates a system according to an embodiment.

FIG. 1B illustrates a system according to an embodiment.

FIG. 2 illustrates a method according to an embodiment.

FIG. 3 illustrates another method according to an embodiment.

FIG. 4 illustrates a controller according to an embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

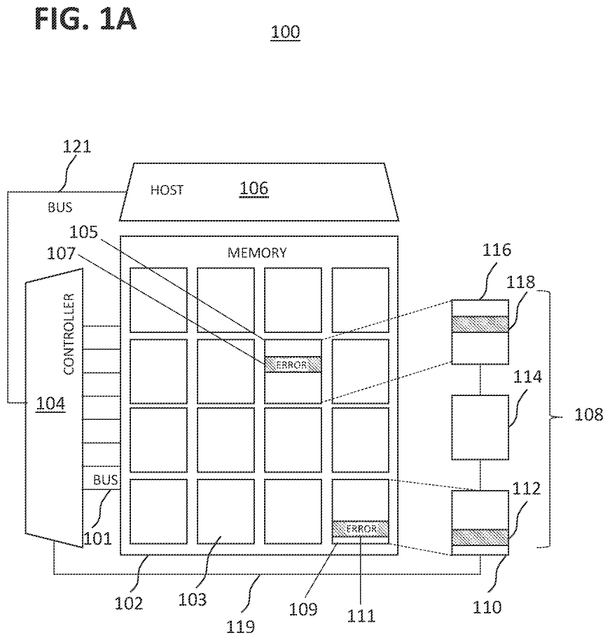

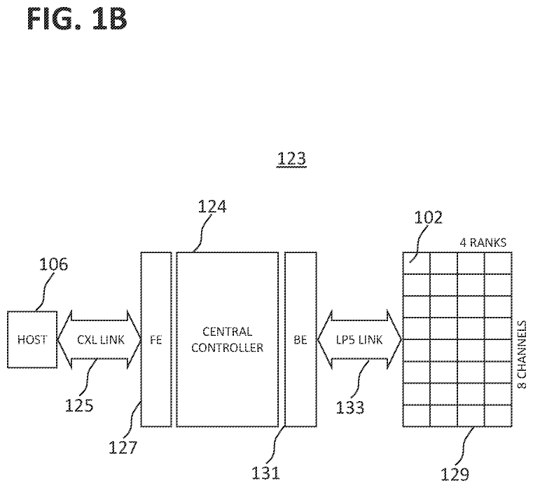

FIG. 1A describes a system 100 according to an embodiment. The system 100 may include a medium (e.g., a memory 102) which includes a plurality of regions (e.g., 103, 109, and 105). In other words, the memory 102 may be a single component that includes sub-blocks (i.e., the regions) which represent banks inside the memory 102. Generally, however, a single region can be an entire bank, or a section (which is a bank with specific failure modes), or merely a single row that is a portion of a section of the memory 102. The memory 102 may be communicatively coupled to the controller 104 via a bus 101, and the controller 104 may be communicatively coupled to a host 106 via a bus 121. The controller 104 may also be communicatively coupled to a jolly bay 108 via a bus 109. The jolly bay 108 may include a plurality of jolly sections (e.g., 110, 114, and 116).

During operation, a patrol scrubber routine or protocol may be executed by the host 106. The patrol scrubber may scan the locations of the memory 102 in order to determine whether the include errors. In an example scenario illustrated in FIG. 1, the patrol scrubber may detect that the memory region 105 has an error at location 107 and further that the memory region 109 has an error at location 111. One of skill in the art will readily appreciate that locations 107 and 111 may be single memory registers, or they may be a plurality of memory sections. Furthermore, these memory locations may or may not be consecutive elements of their respective memory sections.

FIG. 1B illustrates a system 123 according to an embodiment. The system 123 represents an exemplary architecture where the host 106 communicates with a central controller 124 according to a CXL™ protocol. The communication between the host 106 and the central controller 124 may be achieved with an intervening CXL™ link 125 and a front-end block 127 that implements the CXL™ protocol. The central controller 124 may be communicatively coupled to a memory element 129 using an intervening back-end block 131, that includes a memory controller like controller 104. The memory controller can include a PHY interface for communicating with the memory element 129 via an LP5 link 133. For example, and not by limitation, the memory element 129 may include 4 ranks and 8 channels.

Further, the memory element 129 may be a plurality of memory components where a unit in the memory element 129 may be a memory component like the memory 102. For example, and not by limitation, a memory component of the memory element 129 may be composed of 16 banks, and each bank may be composed of a number of sections. Each section may be composed of a number of rows.

Furthermore, for example, and not by limitation, for the host 106, all the management is transparent. The host 106 does not observe any change in the behavior of the CXL™ device, because the central controller 124 properly remaps the areas associating to the logical addresses (host) of different portions of physical locations (physical address). For instance, there may be a block in the central controller 124 that has as input the logical address (sent by the host 106) and as output a physical address that the central controller 124 can modify accordingly to perform off-lining recovery.

In one embodiment, referring to FIG. 1A, the controller 104 may be configured to execute a method that preserves memory access and function to the valid data of the memory sections 105 and 109 while relying on the host to fix the errors that have been detected by the patrol scrubber. Typically, in legacy systems, upon finding the error in a given section by the patrol scrubber, the host would disable that section in order to sanitize it, thus holding access to other valid data in that section. This approach thus slows down execution and increase latency.

In contrast, in the embodiment presented herein, the error is mitigated offline without compromising access to the data in the flagged memory sections. Rather, these data are copied to one or more jolly sections that are provisioned to serve as place holder locations for error mitigation. Once the valid data from the flagged sections are in their respective jolly sections the host 106 can continue program execution by access the jolly locations if the data in the original memory locations are needed.

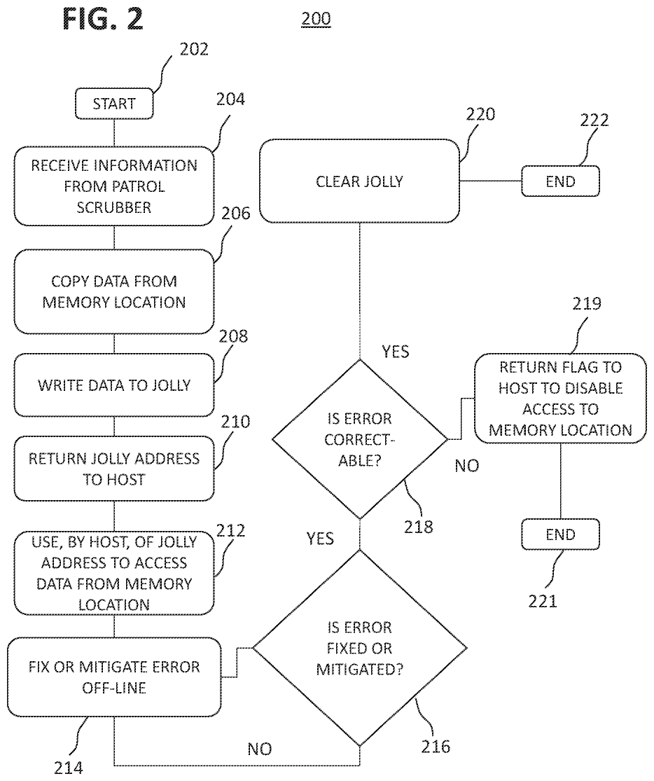

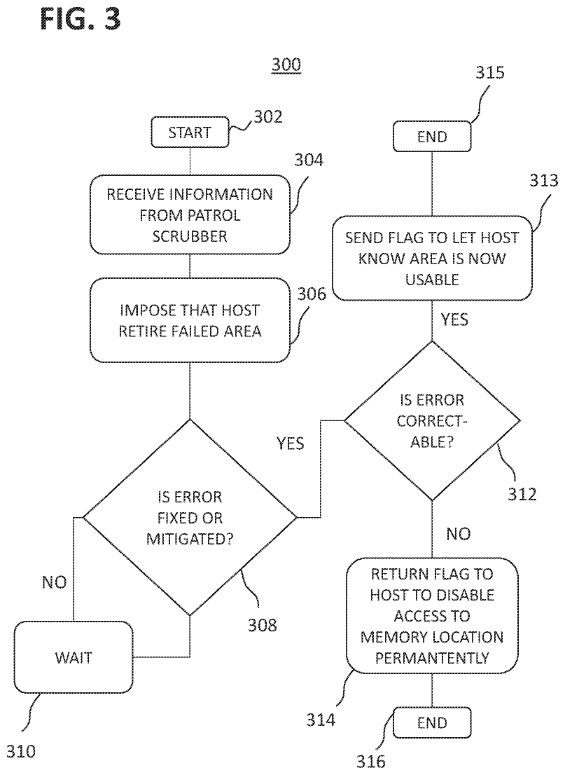

Meanwhile, the error in the original memory section are addressed off-line using typical counter measures (error correcting code, fast cycles, etc.). Once the memory sections that exhibited errors have been sanitized their addresses are usable and the jolly is cleared since the host no longer accesses those data there but rather in the original memory locations. FIG. 2 and FIG. 3 illustrates exemplary methods that may be used to manage errors. One embodiment includes a jolly-based method whereas the other includes a jolly-free approach to off-line error mitigation.

FIG. 2 describes a method 200 according to an embodiment. The method 200 may be executed by the controller 104 to perform one or more tasks associated with off-line management of memory errors. The method 200 has the advantages of keeping memory functions online while an error flagged by a patrol scrubber is fixed offline thereby allowing memory functions to continue unimpeded, thus preserving device speed and throughput.

The method 200 can begin at block 202. The controller 104 may receive information at block 204 from a patrol scrubber that is configured to scrub the memory 102 that a specific memory section includes one or more errors. One of ordinary skill in the art will recognize that such errors may not extend over the whole section, and that as such, despite the one or more errors, the memory section identified may still include valid data.

At block 206, the controller 104 may issue an instruction that causes the valid data, in the memory section to be copied. Upon being copied, the controller 104 may then issue a command for the copied data to be written into a jolly (block 208). The written data may include all the valid data as well as markers to indicate where the corrupted are in the original memory location. Once the data are written into the jolly, the controller 104 may fetch the address of the jolly and return the address of the jolly to the host 106 (block 210).

This may be done with specific instructions to the host to replace the address the of the original memory location with jolly's address. In this scheme program execution, i.e., host tasks may be continued unimpeded, and the data in the original memory location may now be addressed using the jolly's address since the jolly now includes all the valid data of the original memory section that was flagged (block 212). As such, memory functions remain online and program execution continues unimpeded.

Meanwhile, the original location is scheduled by the scrubber to be fixed using, for example and not by limitation, an error-correcting code (block 214). Alternatively, if the error is unrecoverable, the controller 104 may flag the memory section as being unusable. Thus, generally, the error is either fixed or mitigated. The method 200 includes waiting at block 214 if the error is not yet fixed or mitigated (decision block 216).

When the error is fixed or mitigated, the method 200 may include another decision block 218 to determine whether the error that was flagged was recoverable, i.e., correctable, or not. If the error was correctable, the jolly may be cleared (block 220), and the method 200 may end at block 220. If the error was not correctable, the controller 104 or the host 106 may issue a flag asserting that the specific addresses of the memory where the one or more errors occur are unusable since these memory locations include corrupted data or they are damaged (block 219). The method 200 may then end at block 221.

FIG. 3 illustrates a method 300 according to an embodiment. The method 300 begins at block 302, and it includes the controller 104 receiving information from a patrol scrubber. The information is associated with one or more memory locations of the memory 102, and it indicates that the one or more memory locations include errors. In this implementation, a jolly is not used. Rather, at block 306 the controller imposes to the host 106 that the memory sections that have been identified has having errors be retired from use. In other words, the addresses corresponding to the memory sections that have been flagged by the scrubber become unusable.

At decision block 308, the controller 104 checks whether the host 106 has mitigated or fixed the error. If not, the controller 104 waits (block 310). When the error is mitigated or fixed, the controller 104 checks whether the error was recoverable or unrecoverable (decision block 312). If unrecoverable, the controller 104 notifies the host 106 that these memory locations must be retired permanently (block 314), and the method 300 ends at block 316. If the error was recoverable and corrected, the controller 104 sends a flag to the host 106 telling it to remove the memory locations from retirement (block 313). The method 300 then ends at block 315.

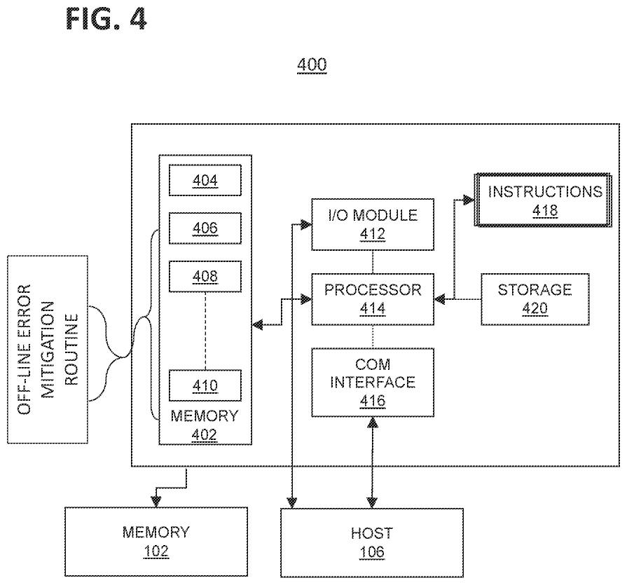

FIG. 4 illustrates a controller 400 that may be an application-specific hardware, software, and firmware implementation of the controller 104 described above. The controller 400 can include a processor 414 configured to executed one or more, or all of the blocks of the method 200, the method 300, or the functions of the system 100 as described above. The processor 414 can have a specific structure. The specific structure can be imparted to the processor 414 by instructions stored in a memory 402 and/or by instructions 418 fetchable by the processor 414 from a storage medium 420. The storage medium 420 may be co-located with the controller 400 as shown, or it can be remote and communicatively coupled to the controller 400. Such communications can be encrypted.

The controller 400 can be a stand-alone programmable system, or a programmable module included in a larger system. For example, the controller 400 can be included in RAS hardware routine for a memory 102 connected to the controller 400. The controller 400 may include one or more hardware and/or software components configured to fetch, decode, execute, store, analyze, distribute, evaluate, and/or categorize information.

The processor 414 may include one or more processing devices or cores (not shown). In some embodiments, the processor 414 may be a plurality of processors, each having either one or more cores. The processor 414 can execute instructions fetched from the memory 402, i.e., from one of memory modules 404, 306, 408, or 410. Alternatively, the instructions can be fetched from the storage medium 420, or from a remote device connected to the controller 400 via a communication interface 416. Furthermore, the communication interface 416 can also interface with the memory 102, for which RAS features are needed, and to the host 106. An I/O module 412 may be configured for additional communications to or from remote systems.

Without loss of generality, the storage medium 420 and/or the memory 402 can include a volatile or non-volatile, magnetic, semiconductor, tape, optical, removable, non-removable, read-only, random-access, or any type of non-transitory computer-readable computer medium. The storage medium 420 and/or the memory 402 may include programs and/or other information usable by processor 414. Furthermore, the storage medium 420 can be configured to log data processed, recorded, or collected during the operation of controller 400.

The data may be time-stamped, location-stamped, cataloged, indexed, encrypted, and/or organized in a variety of ways consistent with data storage practice. By way of example, the memory modules 406 to 410 can form the previously described script autogeneration module. The instructions embodied in these memory modules can cause the processor 414 to perform certain operations consistent with the functions described above, i.e., off-line mitigation of errors flagged within one or more locations of the memory 102.

For example, and not by limitations, the operations can executed by the processor 414 can include receiving, by the processor, information associated with a memory location within the memory 102. The information may indicate an error at the memory location. The operations may then include copying, by the processor, data around the memory location, and placing, by the processor, and the copied data in a reserved area, i.e., in a jolly area which may be co-located with the memory 102. The operations may further include returning, by the processor, a set of addresses to the host 106. The set of addresses are associated with the reserved area, and the set of addresses replaces a corresponding set of addresses of the memory location that were flagged has having errors.

Having described several methods and application-specific embodiments consistent with the teachings presented herein, example general embodiments are now described. For instance, in one embodiment, there is provided a system for mitigating an error in a memory. The system can include a controller configured to receive information associated with a memory location. The information can indicate the error at the memory location.

The controller can be configured to perform, upon receiving the information, certain operations. The operations can include copying data around the memory location, placing the copied data in a reserved area, and returning a set of addresses to a host controller of the memory. The set of addresses may be associated with the reserved area. Furthermore, the set of addresses may replace a corresponding set of addresses of the memory location.

The system may be further configured to fix the error at the memory location using an error correcting code in an off-line mode. And the system may be further configured to operate unimpeded by using the set of addresses to retrieve data from the reserved area where the data correspond to uncorrupted data at the memory location. The controller may be configured to receive the information from a patrol scrubber, which may be associated with the memory system and with other memory systems.

The memory location may span a range of addresses, and one or more addresses be addresses that are specific to where one or more errors occur in the memory location. The system may be further configured to classify the error based on the received information. The controller may be configured to classify the error as recoverable or as unrecoverable. The error may be classified as unrecoverable, and the controller may be configured to notify a host of the memory controller that the memory location has an unrecoverable error. The system may be further configured to remove one or more addresses corresponding to the unrecoverable error from a pool of valid addresses available to the host.

In another embodiment, there is provided a method for mitigating an error in a memory. The method may include receiving, by a controller communicatively coupled to the memory, information associated with a memory location. The information may indicate an error at the memory location. The method may include copying, by the controller, data around the memory location, and placing, by the controller, and the copied data in a reserved area. The method may further include returning, by the controller, a set of addresses to a host controller of the memory. The set of addresses may be associated with the reserved area, and the set of addresses may replace a corresponding set of addresses of the memory location.

The method can further include fixing, by the system, the error at the memory location using an error correcting code in an off-line mode. Furthermore, the system can keep operating unimpeded by using the set of addresses to retrieve data from the reserved area, the data corresponding to uncorrupted data at the memory location. The method can further include receiving, by the controller, the information from a patrol scrubber. The memory location can span a range of addresses, and the range of addresses can include one or more specified addresses where the error is located.

The method can further include classifying, by the controller, the error based on the received information. The method can further include classifying the error as recoverable or as unrecoverable. When the error is classified unrecoverable, the operations include notifying a host of the memory controller that the memory location has an unrecoverable error. The method can further include removing one or more addresses corresponding to the unrecoverable error from a pool of valid addresses available to the host.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A system for mitigating an error in a memory, the system comprising:
a memory controller communicatively coupled to a host, the memory controller being configured to receive information associated with a memory location, the information indicating the error at the memory location, wherein the controller is configured to perform, upon receiving the information, operations including:
copying data around the memory location;
placing the copied data in a reserved area; and
outputting, to a central controller, a set of physical addresses associated with the reserved area, wherein the central controller is configured to modify the set of physical address to conduct a data recovery off-line.

2. The system of claim 1, further including the central controller, and wherein the central controller is configured to received input logical addresses from the host, and wherein further configured to fix the error at the memory location using an error correcting code during the recovery in an off-line mode.

3. The system of claim 2, wherein the system is further configured to operate unimpeded by using the set of physical addresses to retrieve data from the reserved area, the data corresponding to uncorrupted data at the memory location.

4. The system of claim 1, wherein the memory controller is configured to receive the information from a patrol scrubber.

5. The system of claim 1, wherein the memory location spans a range of addresses.

6. The system of claim 5, wherein the range of addresses includes one or more specified addresses where the error is located.

7. The system of claim 1, wherein the memory controller is further configured to classify the error based on the received information.

8. The system of claim 7, wherein the controller is configured to classify the error as recoverable or as unrecoverable.

9. The system of claim 8, wherein when the error is classified as unrecoverable, the controller is further configured to notify a host of the memory controller that the memory location has an unrecoverable error.

10. The system of claim 9, wherein system is further configured to remove one or more addresses corresponding to the unrecoverable error from a pool of valid addresses available to the host.

11. A method for mitigating an error in a memory, the method comprising:
receiving, by a memory controller communicatively coupled to a host, information associated with a memory location, the information indicating the error at the memory location;
copying data around the memory location;
placing the copied data in a reserved area; and
outputting, to a central controller, a set of physical addresses associated with the reserved area; and
modifying the set of physical address to conduct a data recovery off-line.

12. The method of claim 10, further comprising fixing, by the system, the error at the memory location using an error correcting code in an off-line mode.

13. The method of claim 12, further including the system operating unimpeded by using the set of addresses to retrieve data from the reserved area, the data corresponding to uncorrupted data at the memory location.

14. The method of claim 10, further including receiving, by the controller, the information from a patrol scrubber.

15. The method of claim 10, wherein the memory location spans a range of addresses.

16. The method of claim 15, wherein the range of addresses includes one or more specified addresses where the error is located.

17. The method of claim 10, further including classifying, by the controller, the error based on the received information.

18. The method of claim 17, wherein the classifying includes marking the error as recoverable or as unrecoverable.

19. The method of claim 18, wherein when the error is classified unrecoverable, the operations include notifying a host of the memory controller that the memory location has an unrecoverable error.

20. The method of claim 19, further including removing one or more addresses corresponding to the unrecoverable error from a pool of valid addresses available to the host.
